(19) United States
(12) Patent Application Publication
(10) Pub. No.: US 2015/0028032 A1
(43) Pub. Date: Jan. 29, 2015

(54) Hinged container lid opening device and assembly method

(71) Applicant: Neal Flewelling, Toronto (CA)

(72) Inventor: Neal Warren Flewelling, Toronto (CA)

(21) Appl. No.: 13/987,462

(22) Filed: Jul. 29, 2013

(51) Int. Cl. B65F 1/14; B23P 19/00

(52) U.S. Cl. CPC B65F 1/163; B23P 19/00; B65F 2001/1653
USPC 220/263; 29/428

(57) ABSTRACT

The present invention provides an automatic tethering device and assembly method for two wheeled container lids. Container lids are held snugly under a housing enclosure lid as it opens from a closed position then back to a closed position. Two wheeled containers with hinged lids are rolled into a housing enclosure underneath a housing enclosure lid automatically tethering to the housing enclosure lid. Two wheeled containers with hinged lids are then rolled away from the housing enclosure lid automatically detaching from the tether. The elevated rolling tethering assembly for the two wheeled container lid is press fit below the outer surface of the container lid 19.

### RELATED APPLICATION

This application is a Continuation-In-Part of the U.S. patent application Ser. No. 12/923,694 filed on Oct. 5, 2010 by Neal Warren Flewelling for: “Advanced household waste and recycling device and method” claiming the priority date of U.S. provisional application Ser. No. 61/278,149 filed on Oct. 5, 2009

### BACKGROUND

Wheeled containers having hinged lids are commonly used in many cities for waste separation and collection. Various sizes of containers allow for the waste to be quantified in terms of type and volume. They also allow the owner or user to utilize the wheel barrow type qualities when physically moving the filled containers to a pick up location. These containers then allow professional services to utilize lifting devices to empty the containers into the collection truck.

Many homes and business store their own bins in housing enclosures that range from custom types to production horizontal sheds that are purpose built for this application of storing the wheeled containers described. These types of housing structures are mostly used for their organization and screening benefits. These types of housing enclosures also offer an element of protection from the environment, animals, and unwanted use.

In addition to the storage and protection there is also technology available to be used within the storage housing that can enhance the operation of the described container lids and housing enclosure lid. This technology allows a user to simultaneously open container lids using a single foot pedal. This technology provides hands free access for depositing waste and recycling items. This described technology also provides a means of effectively attaching and detaching the container lids to the foot pedal operated storage housing. The tethering configuration maximizes the open angle of the two wheeled container lid when being lifted under the housing enclosure lid. However this technology requires manual attaching and detaching of the tethered connection between the housing enclosure lid and the container lid.

It would be even more beneficial to simplify the procedure of attaching and dethatching the container lids to this type of housing enclosure technology.

Any device or elements used to enhance this procedure would still have to be as good as or better than current tethering devices. A container lid tethering device for use within a two wheeled container housing enclosure is ideally: able to tether the container lids without having to lift the housing enclosure lid open when loading and tethering the container lids to the housing enclosure lid. A secure attachment between the container lid and housing enclosure lid when tethered for operation is required. The maximum amount of container lid open angle relevant to the housing enclosure lid is important for access to accommodate garbage bags passing through the opening created into the two wheeled container. Durability, functionality, cost effective parts and cost effective assembly method are also important for any practical application and cost justification. Ideally a production two wheeled container lid according to the present invention could be used as a conventional lid or be easily modified during production or by an end user. The desired tethering assembly would also ideally conform to the current American National Standard for waste containers.

### SUMMARY

The present invention allows the user to automatically attach and detach wheeled containers with hinged lids to a foot pedal operated housing enclosure lid. The containers are attached or detached by simply inserting the containers or removing them from the housing enclosure. The procedure according to the present invention essentially allows for the plugging in of containers or unplugging them from an outer storage housing. This procedure no longer requires a user to manually attach or detach the containers after rolling the containers into or out of place within the storage housing. The elements of the present invention also maximize the open angle of the container lid transitioning below the upwardly disposed single outer storage housing lid. A production molded two wheeled container lid that is modified according to the present invention can be used as a conventional lid or be easily modified during production or by an end user to operate according to the present invention.

### BRIEF DESCRIPTION OF DRAWINGS

FIG. 1 Is an enlarged left side sectional view of the auto tether lid lifting device in a closed position

FIG. 2 Is an enlarged left side sectional view of the auto tether lid lifting device in an open position

FIG. 3 Is a upper right front enlarged perspective partial sectional view of the auto lid tether assembly attached and detached from the housing enclosure lid

FIG. 4 Is a upper left front perspective partial sectional view of working models reduced to practice according to the present invention.

### DETAILED DESCRIPTION

Referring to FIG. 1 an enlarged side sectional view of the auto tether lid lifting device in a closed position. The embodiment in this drawing shows the semi flexible and resilient safety hook 95 that is bow shaped mounted directly to the underside of the single outer lid 38 with fasteners 120. The tip of the semi flexible and resilient safety hook 95 upper most surfaces is shown slightly higher than the bottom surface of roller 93 indicating the resilient flexibility. The semi flexible and resilient safety hook 95 tip is also formed so as not to have a sharp or pointed end for safety.

The semi flexible and resilient safety hook 95 flexes slightly when the roller 93 automatically attached as the container 20 is pushed into position. When the two wheeled container 20 is rolled backwardly into position the roller 93 roles backwardly once contact is made with the semi flexible and resilient safety hook 95. The material for the semi flexible and resilient safety hook 95 must also be non-corrosive, light weight, and economically feasible. An example of the type of material that can be used with great success is aluminium ⅛″ flat bar of 6061 variety. This particular material retains its shape lifting roller 93 and the attached container lid 19. Once attached the container lid 19 is held shut with the container lid 19 only lifting a minimal distance before the bottom of the semi flexible and resilient safety hook 95 touches the container lid 19 outer surfaces under the single outer lid 38 until activated.

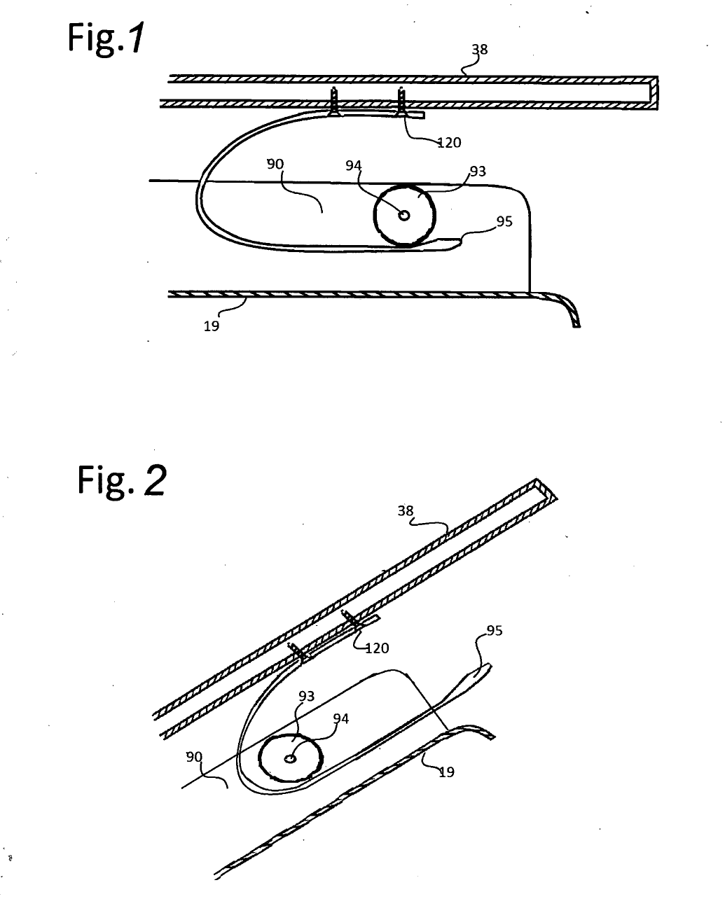

Referring to FIG. 2 the same enlarged left side sectional view of the auto tether lid lifting device is shown in an open position. This drawing demonstrates how the roller 93 rolls backwardly further on the semi flexible and resilient safety hook 95 as the single outer lid and container lid 19 transitions together. This active movement of the roller 93 accommodates the differential in placement of the container lid 19 hinge and the housing enclosure lid 38 as they transition from a closed to open position. This interaction allows the container lid 19 to stay in close proximity to the underside of the housing enclosure lid 38 as it opens.

The roller 93 pivots on projections 94 that extend centrally from each side of the roller 93. Projections 94 are formed from having material removed from each side of the roller 93 when being turned on a lathe. A material used for the roller 93 can be oil impregnated nylon often used as bearing stock. The height of the projections from each side of the roller 93 is equal. The roller 93 length fits between the container lid 19 side wall 90 and side wall 91 formed into container lid 19. The projections 94 then extend from the ends of roller 93 to penetrate the thickness of the container lid 19. The first side wall 90 and second side wall 91 have inline location holes or knock outs formed that fit the projections 94 extending from each side of the roller 93. The side wall 90 and side wall 91 are resilient enough to outwardly expand as the roller 93 is pressed into place until the projections 94 slip into the location hole. When both projections 94 are fit into side wall 90 and side wall 91 the side walls return to an equilibrium position. When the side walls are in equilibrium the width of the roller 93 provides space so that it can rotate freely between side wall 90 and sidewall 91. The height of the roller 93 placed above the inner outer surface of the container lid 19 provides clearance for the semi flexible and resilient safety hook 95. The roller 93 also provides a centrally located handle on top of the container lid 19 when the two wheeled container is not tethered to the housing enclosure lid 38. Without roller 93 installed the container lid functions as a conventional container lid 19. The shape of the formed container lid provides water run off surface and a symmetrical structural configuration that adds rigidity to the generally square shaped container lid 19.

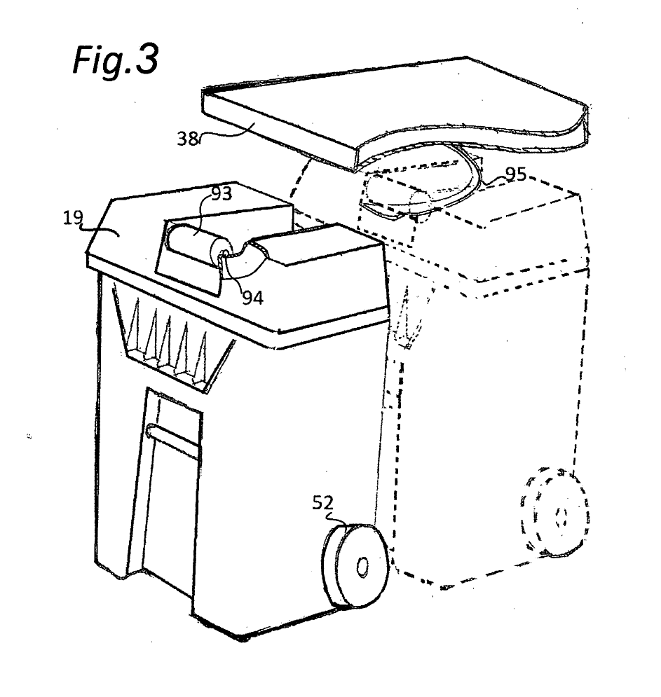

Referring to FIG. 3 an embodiment is shown with a container 20 having a production molded container lid 19 that has provisions for mounting roller 93. The provisions consisting of side wall 90 and side wall 91 formed into container lid 19. Inline hole knock outs are also formed into the container lid 19 for holding projections 94 so that roller 93 is pivotally coupled. The placement of the roller 93 is below the outer surface of the container lid 19 conforming to the American National Standard for two wheeled waste containers. The placement of roller 93 is also above the central container lid 19 outer surface providing clearance for the semi flexible and resilient safety hook 95 for attaching and detaching.

The ghosted line shows the container lid 19 in a closed position attached to the semi flexible and resilient safety hook 95 after being pushed into position. The container 20 shown in solid line is then shown pulled away from the single outer lid 38 automatically releasing or detaching from the semi flexible and resilient safety hook 95 rolling on wheels 52.

The space between the formed container lid 19 side wall 90 and side wall 91 provides the necessary clearance for the semi flexible and resilient safety hook 95 during operation from a closed to open position. This space below the outermost surface of the container lid 19 between side wall 90 and side wall 91 also provides clearance for the semi flexible and resilient safety hook 95 when attaching and detaching the roller 93 for operation. The rearward width of this space allows for an off center approaches of the container 20 as it is rolled backwardly or pushed under the housing enclosure lid 38.

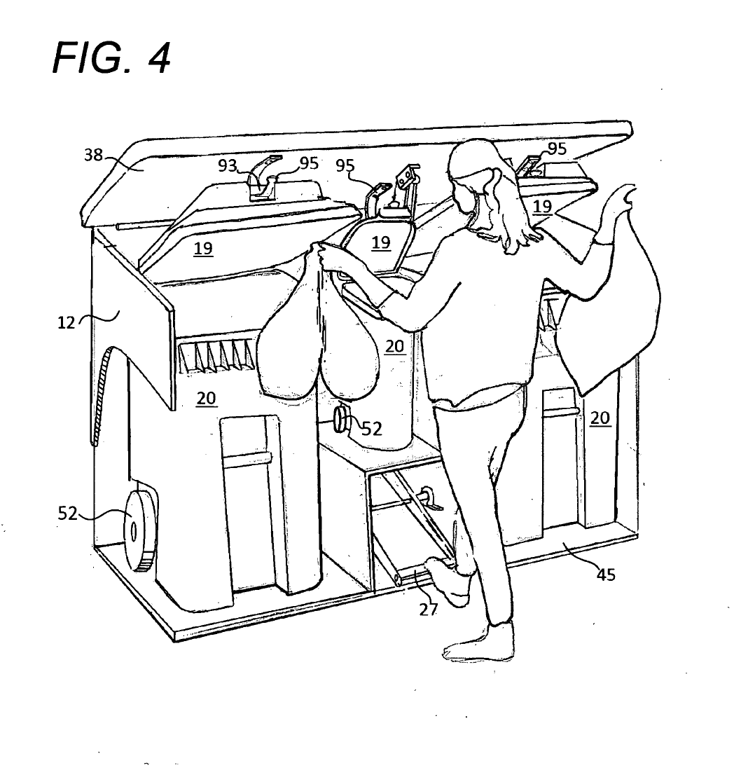

Referring to FIG. 4 A user is shown accessing several containers 20 using foot pedal 27 while holding trash, recycling, and compost collection bags in both hands. The left side wall 12 is shown with a partial section removed in order to show wheel 52 on one of the containers 20. Also shown foot pedal 27 is used to operate a housing enclosure lid 38 outfitted with three sets of the present invention tethering each of the container lids 19.

Housing enclosure lid 38 is shown in an open position with each semi flexible and resilient safety hook 95 suspending each respective roller 93 that have rolled backwardly. A base 45 is also shown as part of the housing structure providing structural support for the housing enclosure. There are many variations of housing enclosures that are constructed for the purpose of storing these types of wheeled containers 20. Some housing enclosures are available without bases or partial bases, still others provide cross pieces spanning between left side wall 12 and right side wall 13.

The height of the roller 93 allows for the lowest point of semi flexible and resilient safety hook 95 to clear the top of container lid 19. This then allows for the container 20 to be rolled towards or away from this position on wheels 52.

Although the disclosure describes and illustrates various embodiments of the invention, it is to be understood that the invention is not limited to these particular embodiments. Many variations and modifications will now occur to those skilled in the art of two wheeled hinge lidded container manufacturing . For full definition of the scope of the invention, reference is to be made to the appended claims.

I claim:

1. A lid tethering device comprising; a semi flexible and resilient safety hook that is bow shaped extending downwardly from a housing enclosure lid disposed above a roller, said roller pivotally coupled to a container lid said container lid pivotally connected to a two wheeled container, said roller contacting the semi flexible and resilient safety hook when said two wheeled container is rolled under said housing enclosure lid both the container lid and housing enclosure lid are in a closed position said roller generally orientated perpendicular to the forward facing semi flexible and resilient safety hook whereby said roller rolls on said semi flexible and resilient safety hook as the container lid and the housing enclosure lid transition from a closed position to an open position.

2. A lid tethering device as claimed in claim 1 having a foot pedal assembly operatively connected to a housing enclosure lid.

3. A lid tethering device as claimed in claim 1 having a housing enclosure with a side wall on each end.

4. A lid tethering device as claimed in claim 1 having a housing enclosure with a back wall

5. A lid tethering device as claimed in claim 1 having a housing enclosure with a base

6. A method of assembling a Lid tethering device including the steps of; pressing a roller that has a projection centrally located on each of a roller so that said projections contact a first side wall and a second side wall then pushing said roller downwardly until said projections fit into a first drop out hole located on the first side wall and a second drop out hole located on the second side wall whereby said first side wall and said second side wall return to an equilibrium position holding the roller above an inner surface.
